(19) United States
(12) Patent Application Publication
(10) Pub. No.: US 2026/0177705 A1
(43) Pub. Date: Jun. 25, 2026

(54) POSITIONING DEVICE AND POSITIONING METHOD

(71) Applicant: SEIKO EPSON CORPORATION, Tokyo (JP)

(72) Inventor: Yotaro DOI, SUWA-SHI (JP)

(73) Assignee: SEIKO EPSON CORPORATION, Tokyo (JP)

(21) Appl. No.: 19/428,347

(22) Filed: Dec. 22, 2025

(30) Foreign Application Priority Data
Dec. 24, 2024 (JP) 2024-227108

(51) Int. Cl. G01S 19/21

(52) U.S. Cl. CPC G01S 19/215

(57) ABSTRACT

A positioning device includes a receiving unit that receives a first satellite signal in a first frequency band and a second satellite signal in a second frequency band transmitted from a first satellite, a positioning unit, a determination unit that compares a value of a predetermined parameter based on the first satellite signal with a value of the predetermined parameter based on the second satellite signal, and determines whether the first satellite is a genuine satellite, and a control unit that controls the positioning unit not to perform positioning using the first satellite signal and the second satellite signal when the determination unit determines that the first satellite is not a genuine satellite.

The present application is based on, and claims priority from JP Application Serial Number 2024-227108, filed Dec. 24, 2024, the disclosure of which is hereby incorporated by reference herein in its entirety.

### BACKGROUND

### 1. Technical Field

The present disclosure relates to a positioning device, a positioning method, and a non-transitory computer-readable storage medium storing a positioning program.

### 2. Related Art

JP-A-2020-201073 describes a positioning device including a satellite information acquisition r that acquires first satellite information generated from radio waves received by a first antenna and second satellite information generated from radio waves received by a second antenna that is an antenna having a narrower coverage than the first antenna, a determination unit that determines whether the first antenna receives disturbing waves based on the first satellite information and determines the second satellite information as satellite information to be used for positioning calculation when it is determined that the first antenna receives the disturbing waves, and positioning calculation unit that performs positioning calculation using the satellite information determined by the determination unit.

JP-A-2020-201073 is an example of the related art.

In the positioning device described in JP-A-2020-201073, when the first antenna receives the disturbing waves, the coverage of the satellite received by the second antenna is narrower, and thus the number of satellites that can be captured is smaller. Therefore, the number of satellites that can be used for positioning is smaller, and positioning accuracy is lower.

### SUMMARY

A positioning device according to an aspect of the present disclosure includes a receiving unit that receives a first satellite signal in a first frequency band and a second satellite signal in a second frequency band different from the first frequency band transmitted from a first satellite, a positioning unit, a determination unit that compares a value of a predetermined parameter contained in first satellite information of the first satellite based on the first satellite signal value of the predetermined parameter contained in second satellite information of the first satellite based on the second satellite signal, and determines whether the first satellite is spoofed, and a control unit that controls the positioning unit not to perform positioning using the first satellite information and the second satellite information of the first satellite when the determination unit determines that the first satellite is spoofed.

A positioning device according to another aspect of the present disclosure includes a receiving unit that receives a first satellite signal in a first frequency band and a second satellite signal in a second frequency band different from the first frequency band transmitted from a first satellite, and receives a third satellite signal in the first frequency band and a fourth satellite signal in the second frequency band transmitted from a second satellite, a positioning unit, a determination unit that compares a first difference as a difference between a value of a predetermined parameter contained in first satellite information of the first satellite based on the first satellite signal and a value of the predetermined parameter contained in second satellite information of the first satellite based on the second satellite signal with a second difference as a difference between a value of the predetermined parameter contained in first satellite information of the second satellite based on the third satellite signal and a value of the predetermined parameter contained in second satellite information of the second satellite based on the fourth satellite signal, and determines whether one of the first satellite and the second satellite is spoofed, and a control unit that controls the positioning unit not to perform positioning using the first satellite information and the second satellite information of the first satellite when the determination unit determines that the first satellite is spoofed, and controls the positioning unit not to perform positioning using the first satellite information and the second satellite information of the second satellite when the determination unit determines that the second satellite is spoofed.

A positioning method according to an aspect of the present disclosure includes a reception step of receiving a first satellite signal in a first frequency band and a second satellite signal in a second frequency band different from the first frequency band transmitted from a first satellite, a positioning step, a determination step of comparing a value of a predetermined parameter contained in first satellite information of the first satellite based on the first satellite signal with a value of the predetermined parameter contained in second satellite information of the first satellite based on the second satellite signal, and determining whether the first satellite is spoofed, and a control step of controlling not to perform positioning using the first satellite information and the second satellite information of the first satellite in the positioning step when it is determined in the determination step that the first satellite is spoofed.

A non-transitory computer-readable storage medium storing a positioning program according to an aspect of the present disclosure, the positioning program causes a computer to execute a positioning step, a determination step of comparing a value of a predetermined parameter contained in first satellite information of a first satellite based on a first satellite signal in a first frequency band transmitted from the first satellite with a value of the predetermined parameter contained in second satellite information of the first satellite based on a second satellite signal in a second frequency band different from the first frequency band transmitted from the first satellite, and determining whether the first satellite is spoofed, and a control step of controlling not to perform positioning using the first satellite information and the second satellite information of the first satellite in the positioning step when it is determined in the determination step that the first satellite is spoofed.

### BRIEF DESCRIPTION OF THE DRAWINGS

FIG. 1 shows a configuration example of a positioning device of a present embodiment.

FIG. 2 shows a configuration of a navigation message in an L1 band in a GPS.

FIG. 3 shows a configuration of a navigation message in an L5 band in the GPS.

FIG. 4 shows orbit determination elements.

FIG. 5 shows a case where a first satellite is not spoofed in a first embodiment.

FIG. 6 shows a case where the first satellite is spoofed in the first embodiment.

FIG. 7 is a flowchart showing an example of a procedure of a positioning method of the present embodiment.

FIG. 8 is a flowchart showing an example of a specific procedure of the positioning method of the first embodiment.

FIG. 9 is a flowchart showing an example of a specific procedure of a positioning method of a second embodiment.

FIG. 10 is a flowchart showing an example of a specific procedure of a positioning method of a third embodiment.

FIG. 11 is a flowchart showing another example of the specific procedure of the positioning method of the third embodiment.

FIG. 12 shows a case where a first satellite is not spoofed in a fourth embodiment.

FIG. 13 shows a case where the first satellite is spoofed in the fourth embodiment.

FIG. 14 is a flowchart showing an example of a specific procedure of a positioning method of the fourth embodiment.

### DESCRIPTION OF EMBODIMENTS

Hereinafter, preferred embodiments of the present disclosure will be described in detail with reference to the drawings. Note that the embodiments to be described below do not unreasonably limit the present disclosure set forth in the appended claims. Furthermore, not all configurations to be described below are necessarily essential component elements of the present disclosure.

### 1. First Embodiment

### 1-1. Configuration of Positioning Device

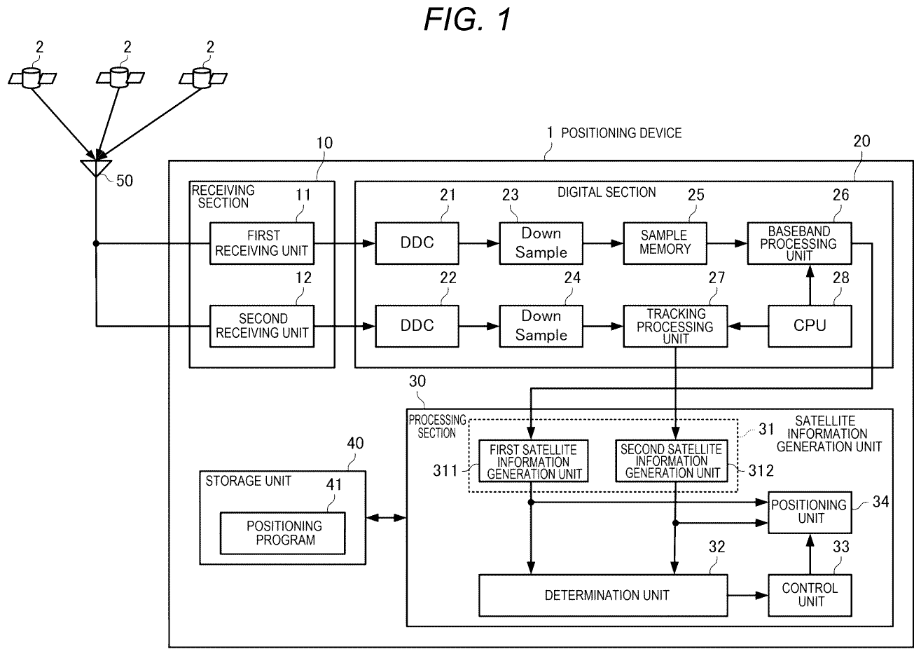

FIG. 1 shows a configuration example of a positioning device 1 of the present embodiment. As will be described in detail below, the positioning device 1 receives satellite signals transmitted from satellites 2 and performs positioning based on the received satellite signals.

As illustrated in FIG. 1, the positioning device 1 of the present embodiment includes an antenna 50, a receiving section 10, a digital section 20, a processing section 30, and a storage section 40. The positioning device 1 may have a configuration in which part of the elements in FIG. 1 is omitted or changed or another element is added.

The antenna 50 is an antenna that receives various radio waves including satellite signals transmitted from each of a plurality of satellites 2. The antenna 50 is, for example, an antenna covering an elevation angle of 0 degrees or more, and can receive radio waves from the satellites 2 over the whole sky. The satellites 2 are artificial satellites traveling in a predetermined orbit above the earth and configure a part of a GNSS. GNSS is an abbreviation for Global Navigation Satellite System. Examples of the GNSS include GPS, QZSS, EGNOS, GLONASS, GALILEO, and BeiDou. GPS is an abbreviation for Global Positioning System. QZSS is an abbreviation for Quasi Zenith Satellite System. EGNOS is an abbreviation for European Geostationary Navigation Overlay Service. GLONASS is an abbreviation for Global Navigation Satellite System. Hereinafter, a case where a satellite system to which the satellites 2 belong is a GPS will be described as an example.

The satellites 2 transmit satellite signals formed by superimposing navigation messages on radio waves in a plurality of frequency bands such as an L1 band having a center frequency at 1.57542 GHZ and an L2 band having a center frequency at 1.22760 GHz to the ground. In the GPS, approximately thirty satellites 2 are present. In order to identify the satellite 2 that transmits the satellite signal, the satellite signal in the L1 band includes an identification code including a specific pattern of 1023 chips. The identification code of the L1 band is called C/A code. Each chip is either +1 or −1, appears like a random pattern, and is repeated at a cycle of 1 ms. C/A is an abbreviation for Coarse/Acquisition Code. As described above, the chip rate of the satellite signal in the L1 band is 1.023 Mcps (=1023 chips/1 ms).

Some of the satellites 2 also transmit satellite signals formed by superimposing navigation messages on radio waves in an L5 band having a center frequency at 1.17645 GHz to the ground. The satellite signal in the L5 band includes an identification code including a specific pattern of 10230 chips. In the identification code, as in the C/A code, each chip is either +1 or −1, appears like a random pattern, and is repeated at a cycle of 1 ms. As described above, the chip rate of the satellite signal in the L5 band is 10.23 Mcps (=10230 chips/1 ms), which is ten times the chip rate of the satellite signal in the L1 band.

The receiving section 10 includes a first receiving unit 11 and a second receiving unit 12. The first receiving unit 11 and the second receiving unit 12 are coupled to the antenna 50. The first receiving unit 11 receives a satellite signal in a first frequency band superimposed on the radio wave received by the antenna 50. The second receiving unit 12 receives a satellite signal in a second frequency band different from the first frequency band superimposed on the radio wave received by the antenna 50. The satellite signal in the first frequency band and the satellite signal in the second frequency band are transmitted from each satellite 2. For example, the first frequency band is one of the L1 band, the L2 band, and the L5 band, and the second frequency band is another one of the L1 band, the L2 band, and the L5 band. Hereinafter, it is assumed that the first frequency band is the L1 band and the second frequency band is the L5 band.

In the present embodiment, the first receiving unit 11 receives the satellite signal in the L1 band transmitted from each satellite 2, converts the received satellite signal into an intermediate frequency signal, and outputs the intermediate frequency signal. Specifically, the first receiving unit 11 extracts the satellite signal in the L1 band from the radio waves received by the antenna 50 using a bandpass filter, amplifies the extracted satellite signal by an LNA, mixes the amplified signal and a clock signal at a predetermined frequency by a mixer, and down-converts the signal into a signal in an intermediate frequency band of, for example, several megahertz. LNA is an abbreviation for Low Noise Amplifier. Then, the first receiving unit 11 performs amplification and low-pass filter processing on the signal in the intermediate frequency band, converts the signal into a digital signal by an AD converter, and outputs the digital signal.

Similarly, the second receiving unit 12 receives the satellite signal in the L5 band transmitted from each satellite 2, converts the received satellite signal into an intermediate frequency signal, and outputs the intermediate frequency signal. Specifically, the second receiving unit 12 extracts the satellite signal in the L5 band from the radio waves received by the antenna 50 using a bandpass filter, amplifies the extracted satellite signal by an LNA, mixes the amplified signal and a clock signal at a predetermined frequency by a mixer, and down-converts the signal into a signal in an intermediate frequency band of, for example, several megahertz. Then, the second receiving unit 12 performs amplification and low-pass filter processing on the signal in the intermediate frequency band, converts the signal into a digital signal by an AD converter, and outputs the digital signal.

As illustrated in FIG. 1, the digital section 20 includes DDCs 21 and 22, down-sampling units 23 and 24, a sample memory 25, a baseband processing unit 26, a tracking processing unit 27, and a CPU 28. DDC is an abbreviation for Digital Down Converter. CPU is an abbreviation for Central Processing Unit.

The DDC 21 converts the intermediate frequency signal as the digital signal output from the first receiving unit 11 into a digital signal having a center frequency of 0 Hz and outputs the digital signal. Specifically, the DDC 21 generates, for example, a sine-wave digital signal at several megahertz, mixes the intermediate frequency signal with the sine-wave digital signal, then performs low-pass filter processing thereon, converts the digital signal into a digital signal having a center frequency of 0 Hz, and outputs the digital signal.

Similarly, the DDC 22 converts the intermediate frequency signal as the digital signal output from the second receiving unit 12 into a digital signal having a center frequency of 0 Hz and outputs the digital signal. Specifically, the DDC 22 generates, for example, a sine-wave digital signal at several megahertz, mixes the intermediate frequency signal with the sine-wave digital signal, then performs low-pass filter processing thereon, converts the digital signal into a digital signal having a center frequency of 0 Hz, and outputs the digital signal.

The down-sampling unit 23 down-samples the digital signal output from the DDC 21 and outputs a baseband signal. Similarly, the down-sampling unit 24 down-samples the digital signal output from the DDC 22 and outputs a baseband signal.

The sample memory 25 sequentially stores the baseband signal output from the down-sampling unit 23. In the present embodiment, the sample memory 25 stores the baseband signals for a time period equal to or more than one cycle of the C/A code contained in the satellite signal in the L1 band received by the first receiving unit 11, that is, for a time period equal to or more than 1 ms.

The baseband processing unit 26 processes the baseband signal stored in the sample memory 25. Specifically, the baseband processing unit 26 generates a local code having the same pattern as that of each C/A code, and performs a satellite search that is processing of obtaining a correlation between each C/A code contained in the baseband signal and the local code. Since each satellite 2 is moving at high speed, the frequency of the satellite signal in the L1 band received by the positioning device 1 varies in a range of about ±2 kHz with respect to 1.57542 GHz due to the Doppler effect. Since a Doppler frequency, which is the frequency corresponding to the variation, is a frequency offset of the satellite signal, the baseband processing unit 26 performs the satellite search in consideration of the frequency offset of the satellite signal. Specifically, the baseband processing unit 26 adjusts the phase and the chip rate of the local code to set the correlation value for each local code to be a peak, and determines that the satellite 2 having the local code as the C/A code is synchronized, that is, the satellite 2 is captured when the correlation value is equal to or more than a threshold.

Note that the GPS employs a CDMA method in which all the satellites 2 transmit satellite signals at the same frequency using different C/A codes. Therefore, the baseband processing unit 26 can search for satellite 2 that can be captured by identifying the C/A code contained in the received satellite signal. CDMA is an abbreviation for Code Division Multiple Access.

When the satellite 2 is captured based on the baseband signal, the baseband processing unit 26 calculates the frequency offset of the satellite signal based on the chip rate, calculates the code phase based on the phase of the local code, and generates satellite capture information containing the frequency offset and the code phase of the satellite signal. The baseband processing unit 26 mixes the local code having the same pattern as the C/A code of each captured satellite 2 and the baseband signal at an appropriate timing based on the frequency offset and the code phase of the satellite signal contained in each satellite capture information, and demodulates a navigation message in the L1 band of each satellite 2.

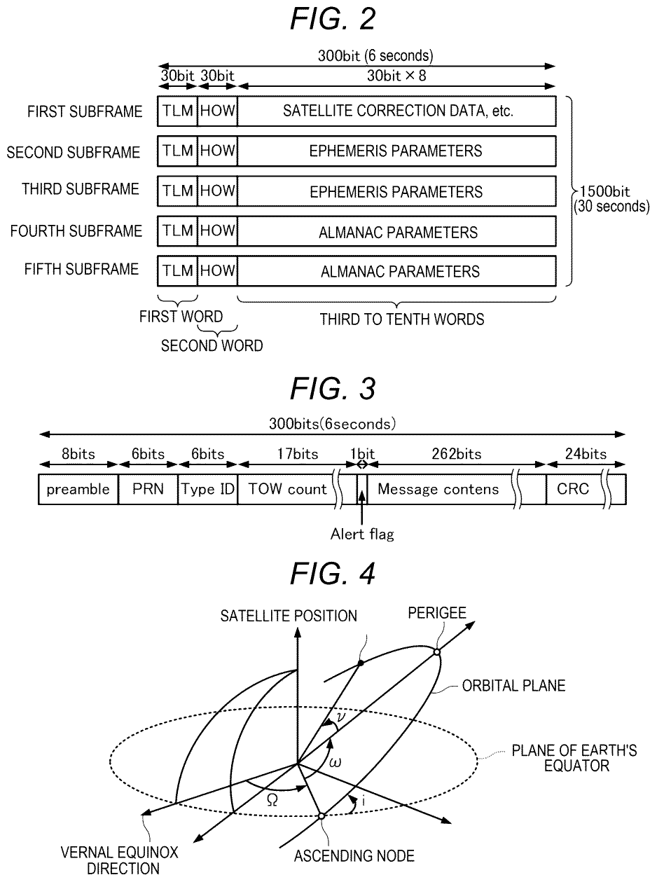

FIG. 2 shows a configuration of the navigation message in the L1 band. As illustrated in FIG. 2, the navigation message in the L1 band is configured as data with a main frame having a total number of bits of 1,500 as one unit. The main frame is divided into first to fifth subframes as five subframes each having 300 bits from the beginning. The data of one subframe is transmitted in six seconds from each satellite 2. Therefore, the data of one main frame is transmitted in thirty seconds from each satellite 2.

The 300-bit data respectively contained in the five subframes is divided into first to tenth words with 30 bits as one word from the beginning. In each subframe, the first word is a TLM word and the second word is a HOW word. TLM is an abbreviation for TeleMetry and HOW is an abbreviation for Hand Over Word. Therefore, the TLM word and the HOW word are transmitted from the satellite 2 at intervals of six seconds.

The TLM word includes preamble data, a TLM message, reserved bits, and parity data.

The HOW word includes time information called TOW or Z count. TOW is an abbreviation for Time Of Week. Z count data is set such that an elapsed time from 0 o'clock on Sunday every week is expressed in seconds and is reset to zero at 0 o'clock on Sunday next week. That is, the Z count data is information in units of seconds indicated every week from the beginning of the week and the elapsed time is a number expressed in units of 1.5 seconds. Here, the Z count data indicates information concerning time when the leading bit of the next subframe data is transmitted. For example, the Z count data of the first subframe indicates information concerning time when the leading bit of the second subframe is transmitted. The HOW word also includes a 3-bit ID code indicating the ID of the subframe. More specifically, the HOW words of the first to fifth subframes include ID codes “001”, “010”, “011”, “100”, and “101”, respectively. The time of the satellite 2 can be calculated from week number data contained in the first subframe and the HOW word contained in each subframe.

The third to tenth words of the first subframe include satellite correction data such as a week number, a state of the satellite 2, and clock correction coefficients. Specifically, the third word includes the week number and the state of the satellite 2 and the eighth to tenth words include the clock correction coefficient. The third to tenth words of each of the second and third subframes include ephemeris parameters, which are detailed orbit information of the satellite 2. The third to tenth words of each of the fourth and fifth subframes include almanac parameters, which are approximate orbit information of all the satellites 2. Therefore, the satellite correction data, the ephemeris parameters, and the almanac parameters are transmitted from the satellite 2 at intervals of thirty seconds.

Referring back to FIG. 1, the tracking processing unit 27 processes the baseband signal output from the down-sampling unit 24. Specifically, the tracking processing unit generates a local code having the same pattern as that of each identification code, and performs a satellite search that is processing of obtaining a correlation between each identification code contained in the baseband signal and the local code. That is, the tracking processing unit adjusts the phase and the chip rate of the local code to set the correlation value for each local code to be a peak, and determines that the satellite 2 having the local code as the identification code is synchronized, that is, the satellite 2 is captured when the correlation value is equal to or more than a threshold.

When the satellite 2 is captured based on the baseband signal, the tracking processing unit 27 calculates the frequency offset of the satellite signal based on the chip rate, calculates the code phase based on the phase of the local code, and generates the satellite capture information containing the frequency offset and the code phase of the satellite signal. The tracking processing unit 27 mixes the local code having the same pattern as the identification code of each captured satellite 2 and the baseband signal at an appropriate timing based on the frequency offset and the code phase of the satellite signal contained in each satellite capture information, and demodulates a navigation message in the L5 band of each satellite 2.

FIG. 3 shows a configuration of the navigation message in the L5 band. As illustrated in FIG. 3, the navigation message in the L5 band is configured as data having a 300-bit message as one unit and is transmitted in six seconds. The 300-bit data configuring each message includes an 8-bit preamble, a 6-bit satellite number PRN, a 6-bit message type ID, a 17-bit message TOW count, a 1-bit alert flag, a 262-bit message content, and a 24-bit CRC from the beginning. CRC is an abbreviation for Cyclic Redundancy Check.

The message TOW count is a TOW count simplified into 17 bits and is expressed in units of six seconds. An actual TOW count is set such that an elapsed time from 0 o'clock on Sunday every week is expressed in seconds and is reset to zero at 0 o'clock on Sunday next week. That is, the actual TOW count data is information in units of seconds indicated every week from the beginning of the week and the elapsed time is a number expressed in units of 1.5 seconds. The actual TOW count simplified and expressed in 17 bits is the message TOW count.

The message content is different depending on the message type ID but includes information that is the same as or similar to the information contained in the navigation message in the L1 band.

Referring back to FIG. 1, the CPU 28 controls operations of the baseband processing unit 26 and the tracking processing unit 27.

As illustrated in FIG. 1, the processing section 30 includes a satellite information generation unit 31, a determination unit 32, a control unit 33, and a positioning unit 34.

The satellite information generation unit 31 includes a first satellite information generation unit 311 and a second satellite information generation unit 312.

The first satellite information generation unit 311 generates first satellite information of each satellite 2 based on the navigation message in the L1 band of each satellite 2 demodulated by the baseband processing unit 26. The first satellite information of each satellite 2 includes values of a plurality of parameters necessary for positioning. The plurality of parameters include a plurality of orbit determination elements for determining the orbit of each satellite 2, the position of each satellite 2, and the like. The first satellite information generation unit 311 can calculate the value of the position of each satellite 2 by performing a known calculation based on the values of the plurality of orbit determination elements of each satellite 2.

As shown in FIG. 4, among the plurality of orbit determination elements used for calculating the value of the position of the satellite 2, the main elements include a right ascension of ascending node Ω, an inclination i, an argument of perigee ω, and a true anomaly ν. The right ascension of ascending node Ω is an angle between a reference direction indicating the vernal equinox and an ascending node in the plane of earth's equator. The inclination i is an angle of an orbital plane with respect to the earth's equator. The argument of perigee ω is an angle from the ascending point to a perigee. The true anomaly ν is an angle in the orbit plane between the perigee and a satellite position at the moment.

As described above, the satellite information generation unit 31 generates the first satellite information of each satellite 2 based on the satellite signal in the L1 band received by the first receiving unit 11 of the receiving section 10, and generates the second satellite information of each satellite 2 based on the satellite signal in the L5 band received by the second receiving unit 12 of the receiving section 10.

The positioning unit 34 performs positioning using the first satellite information or the second satellite information of each satellite 2 generated by the satellite information generation unit 31. For example, the positioning unit 34 calculates the position and the time of the positioning device 1 by solving simultaneous equations using the positions of four or more captured satellites 2 with the three-dimensional coordinates of the position of the positioning device 1 and the time as four variables. The positioning unit 34 may use the position of the satellite 2 contained in the first satellite information of each satellite 2 or the position of the satellite 2 contained in the second satellite information of each satellite 2 for the positioning calculation, but since the position of the satellite 2 contained in the second satellite information is calculated based on the satellite signal in the L5 band having the higher chip rate than the satellite signal in the L1 band and thus has higher resolution, the position of the satellite 2 contained in the second satellite information may be preferentially used.

The determination unit 32 compares the value of the predetermined parameter contained in the first satellite information of each satellite 2 with the value of the predetermined parameter contained in the second satellite information of each satellite 2, and determines whether each satellite 2 is spoofed. In the present embodiment, the predetermined parameter is the position of each satellite 2. That is, the determination unit 32 compares the value of the position of the satellite 2 contained in the first satellite information of each satellite 2 with the value of the position of the satellite 2 contained in the second satellite information of each satellite 2, and determines whether each satellite 2 is spoofed.

For example, the determination unit 32 determines whether each satellite 2 is spoofed based on a difference between the value of the position of the satellite 2 contained in the first satellite information of each satellite 2 and the value of the position of the satellite 2 contained in the second satellite information of each satellite 2.

When the position of the satellite 2 contained in the first satellite information is (x1, y1, z1) and the position of the satellite 2 contained in the second satellite information is (x2, y2, z2), the difference between the position of the satellite 2 contained in the first satellite information and the position of the satellite 2 contained in the second satellite information is a distance d between these two positions and is calculated by Expression (1).

$$d = \sqrt{{( x 2 - x 1 )}^{2} + {( y 2 - y 1 )}^{2} + {( z 2 - z 1 )}^{2}} \qquad ( 1 )$$

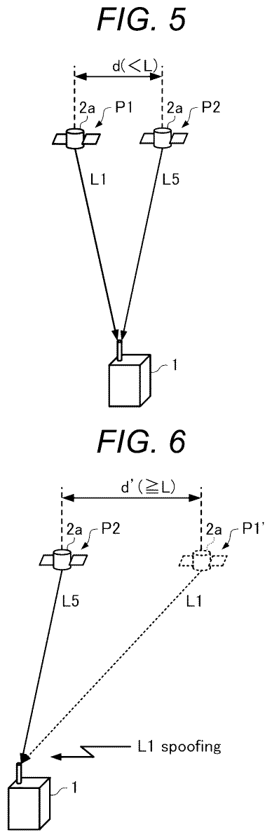

For example, as shown in FIG. 5, at a certain time, a position P1 of a certain first satellite 2a among the plurality of satellites 2 calculated based on the satellite signal in the L1 band transmitted from the first satellite 2a and a position P2 of the first satellite 2a calculated based on the satellite signal in the L5 band transmitted from the first satellite 2a are ideally the same, and the distance d as a difference between the position P1 and the position P2 is supposed to be actually less than a predetermined threshold L. In contrast, as shown in FIG. 6, when the satellite signal of the L1 band transmitted from the first satellite 2a is subjected to a spoofing attack, since the position of the first satellite 2a calculated based on the satellite signal in the L1 band is a position P1′ far from the actual position, a distance d′ as a difference between the position P1′ and the position P2 is equal to or more than the predetermined threshold L.

Therefore, the determination unit 32 can determine whether the first satellite 2a is spoofed based on the difference between the value of the position of the first satellite 2a contained in the first satellite information of the first satellite 2a and the value of the position of the first satellite 2a contained in the second satellite information of the first satellite 2a. Specifically, the determination unit 32 determines that the first satellite 2a is not spoofed when the difference between the value of the position of the first satellite 2a contained in the first satellite information of the first satellite 2a and the value of the position of the first satellite 2a contained in the second satellite information of the first satellite 2a is less than the predetermined threshold, and determines that the first satellite 2a is spoofed when the difference is equal to or more than the predetermined threshold. The threshold is set to a value more than an error range of the position of the first satellite 2a so that an error and a spoofing attack can be distinguished. Since the error range of the position of the first satellite 2a depends on the accuracy requirements of the application and the system, the threshold is also set to a value according to the accuracy requirements.

When the determination unit 32 determines that the first satellite 2a is spoofed, the control unit 33 controls the positioning unit 34 not to perform positioning using the first satellite information and the second satellite information of the first satellite 2a. Accordingly, the positioning unit 34 performs positioning first using the satellite information or the second satellite information of the four or more satellites 2 except the first satellite 2a among the plurality of captured satellites 2.

The storage section 40 stores programs, data, and the like used for processing of the processing section 30. The storage section 40 is also used as a work area of the processing section 30, and temporarily stores calculation results and the like of the processing section 30. In the present embodiment, the processing section 30 is, for example, a CPU, and functions as the satellite information generation unit 31, the determination unit 32, the control unit 33, and the positioning unit 34 by executing a positioning program 41 stored in the storage section 40.

That is, in the positioning device 1 of the present embodiment, the receiving section 10 and the digital section 20 are implemented by hardware, and the processing section 30 is implemented by software. However, at least a part of the digital section 20 may be implemented by software, and at least a part of the processing section 30 may be implemented by hardware.

### 1-2. Positioning Method

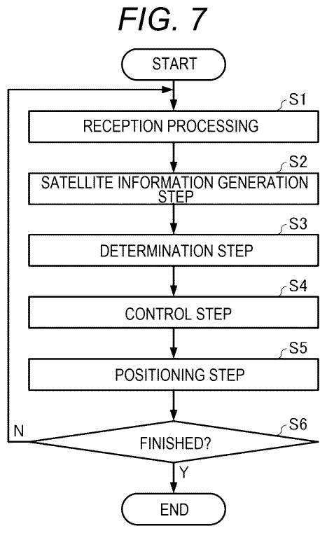

FIG. 7 is a flowchart showing an example of a procedure of a positioning method performed by the positioning device 1 of the present embodiment.

First, in a reception step S1, the receiving section 10 receives the satellite signal in the L1 band and the satellite signal in the L5 band transmitted from each first satellite 2a of the plurality of satellites 2.

Then, in a satellite information generation step S2, the satellite information generation unit 31 generates the first satellite information of each satellite 2 based on the satellite signal in the L1 band received by the receiving section 10 in step S1, and generates the second satellite information of each satellite 2 based on the satellite signal in the L5 band received by the receiving section 10 in step S1.

Then, in a determination step S3, the determination unit 32 compares the value of the predetermined parameter contained in the first satellite information of each satellite 2 generated by the satellite information generation unit 31 in step S2 with the value of the predetermined parameter contained in the second satellite information of each satellite 2 generated by the satellite information generation unit 31 in step S2, and determines whether each satellite 2 is spoofed.

Then, in a control step S4, when it is determined in the determination step S3 that any of the satellite 2 is spoofed, the control unit 33 performs control not to perform positioning using the first satellite information and the second satellite information of the satellite 2 in a positioning step S5.

Then, in the positioning step S5, the positioning unit 34 performs positioning using the first satellite information and the second satellite information of the plurality of satellites 2 except the satellite 2 determined as being spoofed.

Then, the processing in steps S1 to S5 is repeated until the positioning is finished in step S6.

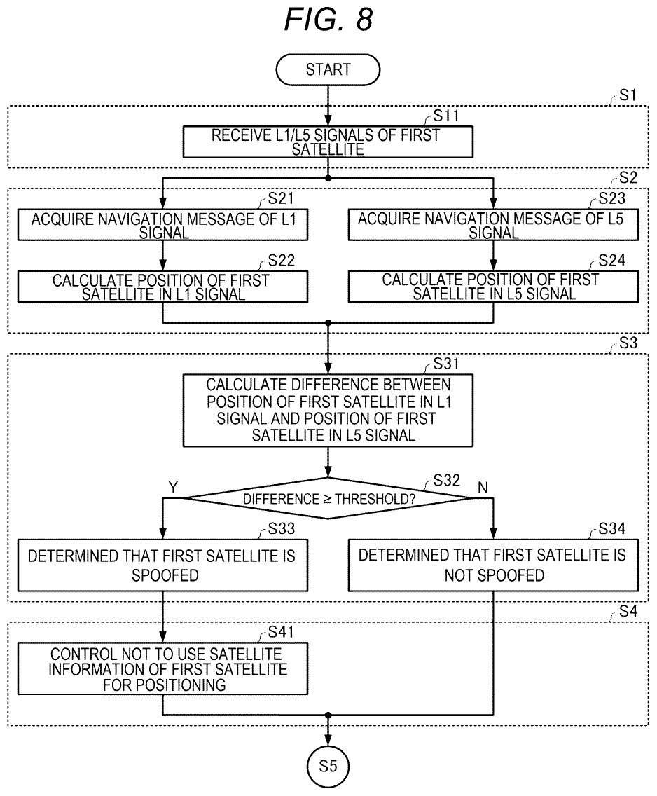

FIG. 8 is a flowchart showing an example of the procedure of the positioning method with a focus on a spoofing determination with respect to a certain first satellite 2a among the plurality of satellites 2 regarding steps S1 to S5 of the flowchart shown in FIG. 7.

As shown in FIG. 8, first, in step S11 contained in the reception step S1, the receiving section 10 receives the first satellite signal in the L1 band and the second satellite signal in the L5 band transmitted from the first satellite 2a.

Then, in steps S21, S22, S23, and S24 contained in the satellite information generation step S2, the satellite information generation unit 31 generates the first satellite information of the first satellite 2a based on the first satellite signal received by the receiving section 10 in step S11, and generates the second satellite information of the first satellite 2a based on the second satellite signal received by the receiving section 10 in step S11.

Specifically, in step S21, the satellite information generation unit 31 acquires the navigation message of the first satellite signal in the L1 band from the baseband processing unit 26, and, in step S22, calculates the position of the first satellite 2a in the first satellite signal in the L1 band based on the navigation message acquired in step S21. For calculation of the position of the first satellite 2a in the first satellite signal, a plurality of orbit determination elements of the first satellite 2a in the first satellite signal are used, and the satellite information generation unit 31 generates the first satellite information including values of a plurality of parameters such as the position of the first satellite 2a and the orbit determination elements.

Furthermore, in step S23, the satellite information generation unit 31 acquires the navigation message of the second satellite signal in the L5 band from the tracking processing unit 27, and, in step S24, calculates the position of the first satellite 2a in the second satellite signal in the L5 band based on the navigation message acquired in step S23. For calculation of the position of the first satellite 2a in the second satellite signal, a plurality of orbit determination elements of the first satellite 2a in the second satellite signal are used, and the satellite information generation unit 31 generates the second satellite information including values of a plurality of parameters such as the position of the first satellite 2a and the orbit determination elements.

Then, in steps S31, S32, S33, and S34 contained in the determination step S3, the determination unit 32 compares the value of a predetermined parameter contained in the first satellite information of the first satellite 2a based on the first satellite signal generated by the satellite information generation unit 31 in step S2 with the value of the predetermined parameter contained in the second satellite information of the first satellite 2a based on the second satellite signal generated by the satellite information generation unit 31 in step S2, and determines whether the first satellite 2a is spoofed. In the present embodiment, the predetermined parameter is the position of the first satellite 2a, and the determination unit 32 determines whether the first satellite 2a is spoofed based on the difference between the value of the position of the first satellite 2a contained in the first satellite information of the first satellite 2a and the value of the position of the first satellite 2a contained in the second satellite information of the first satellite 2a.

Specifically, in step S31, the determination unit 32 calculates the difference between the position of the first satellite 2a in the first satellite signal in the L1 band calculated in step S22 and the position of the first satellite 2a in the second satellite signal in the L5 band calculated in step S24. Then, when the difference calculated in step S31 is equal to or more than the threshold in step S32, the determination unit 32 determines that the first satellite 2a is spoofed in step S33, and when the difference is less than the threshold in step S32, determines that the first satellite 2a is not spoofed in step S34.

Then, in step S41 contained in the control step S4, when it is determined in the determination step S3 that the first satellite 2a is spoofed, the control unit 33 performs control not to perform positioning using the first satellite information and the second satellite information of the first satellite 2a in the positioning step S5.

When it is determined that the first satellite 2a is spoofed, the positioning unit 34 performs positioning without using the first satellite information and the second satellite information of the first satellite 2a in the positioning step S5.

In the present embodiment, the processing section 30 executes the processing in steps S2 to S5 in FIGS. 7 and 8 by executing the positioning program 41. In other words, the positioning program 41 is a program that causes the processing section 30 as a computer to execute each procedure in steps S2 to S5 in FIGS. 7 and 8.

### 1-3. Functions and Effects

As described above, in the positioning device 1 of the first embodiment, when the satellite signal in the L1 band and the satellite signal in the L5 band of the first satellite 2a are not subjected to a spoofing attack, the difference between the value of the predetermined parameter contained in the first satellite information of the first satellite 2a and the value of the predetermined parameter contained in the second satellite information of the first satellite 2a is smaller. In contrast, when the satellite signal in the L1 band or the satellite signal in the L5 band of the first satellite 2a is subjected to a spoofing attack, the difference between the value of the predetermined parameter contained in the first satellite information of the first satellite 2a and the value of the predetermined parameter contained in the second satellite information of the first satellite 2a is larger. Therefore, according to the positioning device 1 of the first embodiment, it is possible to determine whether the first satellite 2a is spoofed by comparing the value of the predetermined parameter contained in the first satellite information of the first satellite 2a with the value of the predetermined parameter contained in the second satellite information of the first satellite 2a. Furthermore, according to the positioning device 1 of the first embodiment, when it is determined that the first satellite 2a is spoofed, the positioning is not performed by using the first satellite information and the second satellite information of the first satellite 2a, thereby reducing the possibility of a false positioning result in an environment of the spoofing attack.

Moreover, in the positioning device 1 of the first embodiment, since a spoofing can be determined using the first satellite signal in a first frequency band such as the L1 band and the second satellite signal in a second frequency band such as the L5 band different from the first frequency band, it is not necessary to receive the satellite signal using an antenna having a narrower coverage. Therefore, according to the positioning device 1 of the first embodiment, the positioning can be performed without reducing the number of captured satellites 2 as much as possible even in the environment of the spoofing attack, and thus it is possible to reduce the possibility of lowering of the positioning accuracy.

In the positioning device 1 of the first embodiment, since the position of the first satellite 2a is calculated by using a large number of orbit determination elements, when some of these orbit determination elements become false values by a spoofing attack, the calculated position value is also false. Therefore, according to the positioning device 1 of the first embodiment, it is possible to accurately determine whether the first satellite 2a is spoofed based on the difference between the value of the position contained in the first satellite information of the first satellite 2a and the value of the position contained in the second satellite information of the first satellite 2a.

### 2. Second Embodiment

Hereinafter, in a second embodiment, the same component elements as those in the first embodiment have the same signs, the overlapping description with that in the first embodiment will be omitted or simplified, and the differences from the first embodiment will be mainly described.

The configuration of the positioning device 1 of the second embodiment is the same as that in FIG. 1, and the illustration and description thereof will be omitted. However, in the positioning device 1 of the second embodiment, the processing of the determination unit 32 is different from that of the first embodiment. In the second embodiment, like the first embodiment, the determination unit 32 compares the value of the predetermined parameter contained in the first satellite information of each satellite 2 with the value of the predetermined parameter contained in the second satellite information of each satellite 2 and determines whether each satellite 2 is spoofed, however, unlike the first embodiment, the predetermined parameter is an orbit determination element of each satellite 2. That is, the determination unit 32 compares the value of the orbit determination element of the satellite 2 contained in the first satellite information of each satellite 2 with the value of the orbit determination element of the satellite 2 contained in the second satellite information of each satellite 2, and determines whether each satellite 2 is spoofed.

For example, the determination unit 32 determines whether each satellite 2 is spoofed based on a difference between the value of the orbit determination element of the satellite 2 contained in the first satellite information of each satellite 2 and the value of the orbit determination element of the satellite 2 contained in the second satellite information of each satellite 2.

At a certain time, the value of the orbit determination element calculated based on the satellite signal in the L1 band transmitted from a certain first satellite 2a among the plurality of satellites 2 and the value of the orbit determination element calculated based on the satellite signal in the L5 band transmitted from the first satellite 2a are ideally the same, and the difference between the two values of the orbit determination element is supposed to be actually less than a predetermined threshold. In contrast, when the satellite signal of the L1 band transmitted from the first satellite 2a is subjected to a spoofing attack, the orbit determination element of the first satellite 2a calculated based on the satellite signal in the L1 band is a value far from the actual value, and therefore, the difference between the two values of the orbit determination element is equal to or more than the predetermined threshold.

Therefore, the determination unit 32 can determine whether the first satellite 2a is spoofed based on the difference between the orbit determination element of the first satellite 2a contained in the first satellite information of the first satellite 2a and the value of the orbit determination element of the first satellite 2a contained in the second satellite information of the first satellite 2a. Specifically, the determination unit 32 determines that the first satellite 2a is not spoofed when the difference between the value of the orbit determination element of the first satellite 2a contained in the first satellite information of the first satellite 2a and the value of the orbit determination element of the first satellite 2a contained in the second satellite information of the first satellite 2a is less than the predetermined threshold, and determines that the first satellite 2a is spoofed when the difference is equal to or more than the predetermined threshold. The threshold is set to a value more than an error range of the orbit determination element of the first satellite 2a so that an error and a spoofing attack can be distinguished. Since the error range of the orbit determination element of the first satellite 2a depends on the accuracy requirements of the application and the system, the threshold is also set to a value according to the accuracy requirements.

Examples of the orbit determination element used for the comparison by the determination unit 32 include the right ascension of ascending node Ω, the inclination i, the argument of perigee ω, and the true anomaly ν illustrated in FIG. 4. The right ascension of ascending node Ω, the inclination i, the argument of perigee ω, and the true anomaly ν are main elements among a plurality of orbit determination elements used for calculating the position of the first satellite 2a.

Since the scales of the values of the right ascension of ascending node Ω, the inclination i, and the argument of perigee ω contained in the navigation message in the L1 band are different from the scales of the values of the right ascension of ascending node Ω, the inclination i, and the argument of perigee @ contained in the navigation message in the L5 band, the determination unit 32 compares the values after adjusting the scales of the values. Furthermore, the determination unit 32 calculates and compares the true anomalies ν from the navigation message in the L1 band and the navigation message in the L5 band by different calculation formulas.

The other configurations and functions of the positioning device 1 of the second embodiment are the same as those of the positioning device 1 of the first embodiment, and thus description thereof will be omitted.

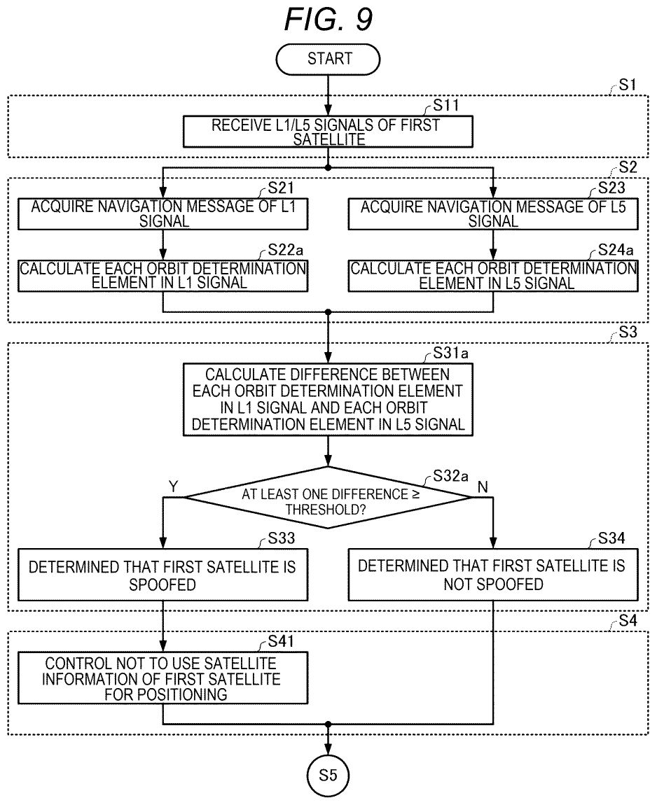

A flowchart illustrating an example of a a procedure of positioning method performed by the positioning device 1 of the second embodiment is the same as that in FIG. 7, and the illustration and description thereof will be omitted. FIG. 9 is a flowchart showing an example of the procedure of the positioning method with a focus on a spoofing determination with respect to a certain first satellite 2a among the plurality of satellites 2 regarding steps S1 to S5 of the flowchart shown in FIG. 7. In FIG. 9, the same steps as those in FIG. 7 have the same signs.

As shown in FIG. 9, first, in step S11 contained in a reception step S1, the receiving section 10 receives the first satellite signal in the L1 band and the second satellite signal in the L5 band transmitted from the first satellite 2a.

Then, in steps S21, S22a, S23, and S24a contained in a satellite information generation step S2, the satellite information generation unit 31 generates the first satellite information of the first satellite 2a based on the first satellite signal received by the receiving section 10 in step S11, and generates the second satellite information of the first satellite 2a based on the second satellite signal received by the receiving section 10 in step S11.

Specifically, in step S21, the satellite information generation unit 31 acquires the navigation message of the first satellite signal in the L1 band from the baseband processing unit 26, and, in step S22a, calculates each orbit determination element of the first satellite 2a in the first satellite signal in the L1 band based on the navigation message acquired in step S21. The orbit determination elements calculated in step S22a are, for example, the right ascension of ascending node Ω, the inclination i, the argument of perigee ω, and the true anomaly ν, and the satellite information generation unit 31 generates the first satellite information including values of a plurality of parameters such as these orbit determination elements.

Furthermore, in step S23, the satellite information generation unit 31 acquires the navigation message of the second satellite signal in the L5 band from the tracking processing unit 27, and, in step S24a, calculates each orbit determination element of the first satellite 2a in the second satellite signal in the L5 band based on the navigation message acquired in step S23. The orbit determination elements calculated in step S24a are the same as the orbit determination elements calculated in steps S22a and S24a, and are, for example, the right ascension of ascending node Ω, the inclination i, the argument of perigee ω, and the true anomaly ν. The satellite information generation unit 31 generates the second satellite information including values of a plurality of parameters such as these orbit determination elements.

Then, in steps S31a, S32a, S33, and S34 contained in a determination step S3, the determination unit 32 compares the value of a predetermined parameter contained in the first satellite information of the first satellite 2a based on the first satellite signal generated by the satellite information generation unit 31 in step S2 with the value of the predetermined parameter contained in the second satellite information of the first satellite 2a based on the second satellite signal generated by the satellite information generation unit 31 in step S2, and determines whether the first satellite 2a is spoofed. In the present embodiment, the predetermined parameter is an orbit determination element of the first satellite 2a, and includes, for example, the right ascension of ascending node Ω, the inclination i, the argument of perigee ω, and the true anomaly ν. The determination unit 32 determines whether the first satellite 2a is spoofed based on the difference between the value of the orbit determination element of the first satellite 2a contained in the first satellite information of the first satellite 2a and the value of the orbit determination element of the first satellite 2a contained in the second satellite information of the first satellite 2a.

Specifically, in step S31a, the determination unit 32 calculates a difference between each orbit determination element in the first satellite signal in the L1 band calculated in step S22a and each orbit determination element in the second satellite signal in the L5 band calculated in step S24a. Then, when at least one difference calculated in step S31a is equal to or more than a threshold in step S32a, the determination unit 32 determines that the first satellite 2a is spoofed in step S33, and when all the differences are less than the threshold in step S32a, determines that the first satellite 2a is not spoofed in step S34.

Then, in step S41 contained in the control step S4, when it is determined in the determination step S3 that the first satellite 2a is spoofed, the control unit 33 performs control not to perform positioning using the first satellite information and the second satellite information of the first satellite 2a in the positioning step S5.

When it is determined that the first satellite 2a is spoofed, the positioning unit 34 performs positioning without using the first satellite information and the second satellite information of the first satellite 2a in the positioning step S5.

In the present embodiment, the processing section 30 executes the processing in steps S2 to S5 in FIGS. 7 and 9 by executing the positioning program 41. In other words, the positioning program 41 is a program that causes the processing section 30 as a computer to execute each procedure in steps S2 to S5 in FIGS. 7 and 9.

According to the positioning device 1 of the second embodiment, it is possible to easily determine whether the first satellite 2a is spoofed based on the difference between the value of the orbit determination element contained in the first satellite information of the first satellite 2a and the value of the orbit determination element contained in the second satellite information of the first satellite 2a. Furthermore, according to the positioning device 1 of the second embodiment, it is not necessary to calculate the position of the first satellite 2a in order to determine whether the first satellite 2a is spoofed, thereby reducing the processing load.

In addition, according to the positioning device 1 of the second embodiment, the same effects as those of the positioning device 1 of the first embodiment can be obtained.

### 3. Third Embodiment

Hereinafter, in a third embodiment, the same component elements as those in the first embodiment or the second embodiment have the same signs, the overlapping description with that in the first embodiment or the second embodiment will be omitted or simplified, and the differences from the first embodiment or the second embodiment will be mainly described.

The configuration of the positioning device 1 of the third embodiment is the same as that in FIG. 1, and the illustration and description thereof will be omitted. However, in the positioning device 1 of the third embodiment, the processing of the determination unit 32 is different from that of the first embodiment and the second embodiment. In the third embodiment, the determination unit 32 has two determination modes of a first determination mode and a second determination mode.

The first determination mode is a determination mode for comparing the value of the position of the satellite 2 contained in the first satellite information of each satellite 2 with the value of the position of the satellite 2 contained in the second satellite information of each satellite 2 and determining whether each satellite 2 is spoofed. That is, in the first determination mode, the determination unit 32 performs the same spoofing determination as that in the first embodiment. When the determination unit 32 performs the spoofing determination in the first determination mode, the satellite information generation unit 31 calculates the position of each satellite 2 by using the navigation message in the L1 band, calculates the position of each satellite 2 by using the navigation message in the L5 band, and generates the first satellite information and the second satellite information each including the value of the position of each satellite 2.

The second determination mode is a determination mode for comparing the value of the orbit determination element of the satellite 2 contained in the first satellite information of each satellite 2 with the value of the orbit determination element of the satellite 2 contained in the second satellite information of each satellite 2 and determining whether each satellite 2 is spoofed. That is, in the second determination mode, the determination unit 32 performs the same spoofing determination as that in the second embodiment. When the determination unit 32 performs a spoofing determination in the second determination mode, the satellite information generation unit 31 calculates the orbit determination element of each satellite 2 using the navigation message in the L1 band, calculates the orbit determination element of each satellite 2 using the navigation message in the L5 band, and generates the first satellite information and the second satellite information each including the value of the orbit determination element of each satellite 2.

In the first determination mode, the determination is performed based on the comparison between the positions of the respective satellites 2, and thus the security level is “strong” and an advanced spoofing countermeasure is realized, but since it is necessary to calculate both the position based on the satellite signal of the L1 band and the position based on the satellite signal of the L5 band for each satellite 2, the processing load is larger. In contrast, in the second determination mode, the determination based on the comparison between the orbit determination elements of the respective satellites 2 is performed, and thus the security level is “weak” and a simple spoofing countermeasure is realized, but since it is not necessary to calculate the position based on the satellite signal of the L1 band or the position based on the satellite signal of the L5 band for each satellite 2, the processing load is smaller. Therefore, the determination unit 32 performs the spoofing determination by switching between the first determination mode and the second determination mode in consideration of the situation of the processing load on the processing section 30 and the caution level to the spoofing attack. For example, when the processing load on the processing section 30 is high, the second determination mode is selected because the resources cannot be allocated to spoofing processing. For example, when there is a high possibility that the area is in the spoofing attack environment, the first determination mode is selected in order to increase the security level. For example, whether the area is in the spoofing attack environment is determined based on information with or without a spoofing attack in the past in the area where the positioning device 1 is located.

The other configurations and functions of the positioning device 1 of the third embodiment are the same as those of the first embodiment or the second embodiment, and thus the description thereof will be omitted.

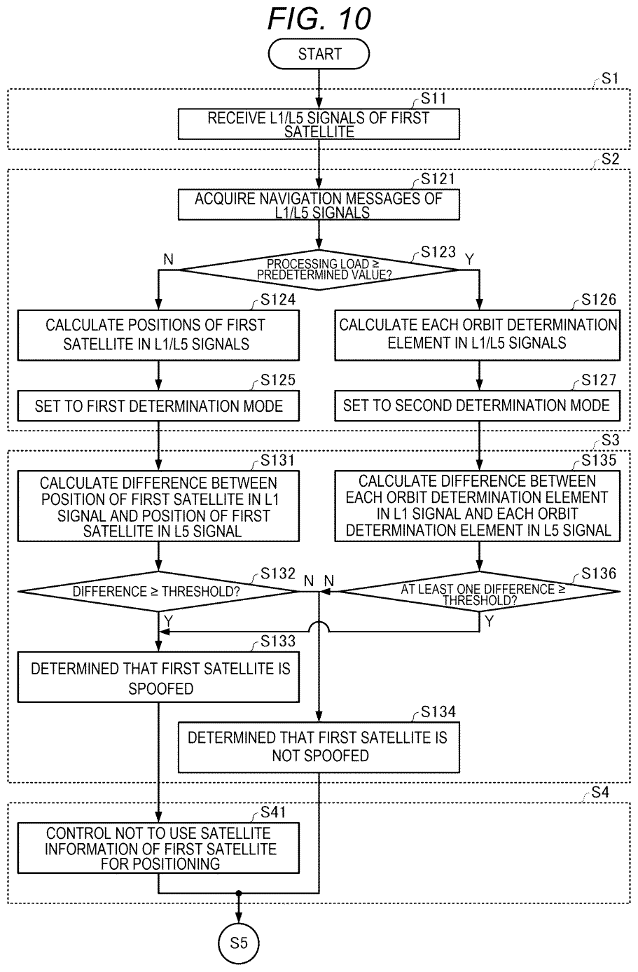

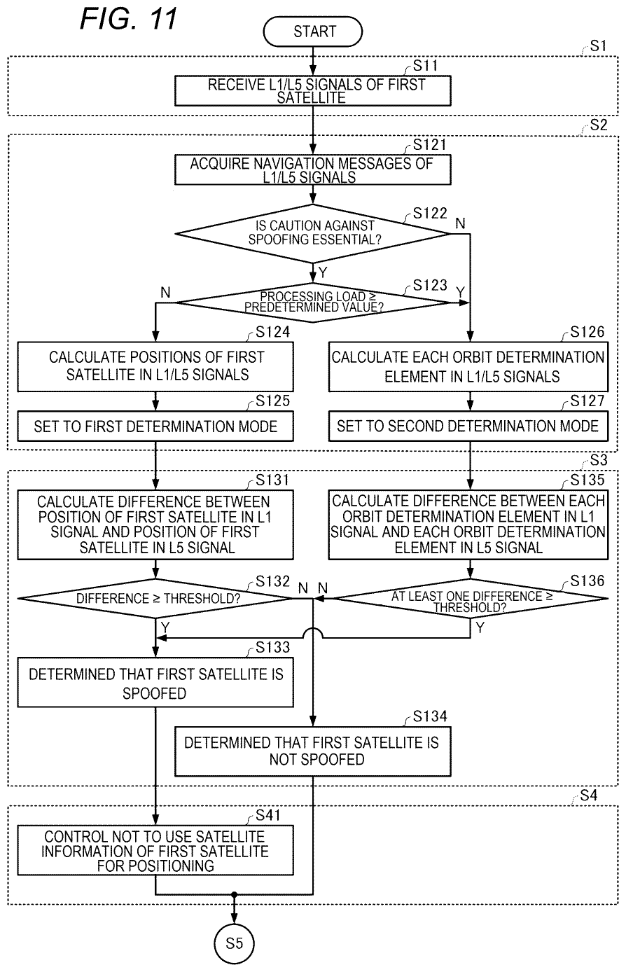

A flowchart showing an example of a procedure of a positioning method performed by the positioning device 1 of the third embodiment is the same as that in FIG. 7, and the illustration and description thereof will be omitted. FIG. 10 is a flowchart showing an example of the procedure of the positioning method with a focus on a spoofing determination with respect to a certain first satellite 2a among the plurality of satellites 2 regarding steps S1 to S5 of the flowchart shown in FIG. 7. In FIG. 10, the same steps as those in FIG. 7 have the same signs.

As shown in FIG. 10, first, in step S11 contained in a reception step S1, the receiving section 10 receives the first satellite signal in the L1 band and the second satellite signal in the L5 band transmitted from the first satellite 2a.

Then, in steps S121 to S127 contained in a satellite information generation step S2, the satellite information generation unit 31 generates the first satellite information of the first satellite 2a based on the first satellite signal received by the receiving section 10 in step S11, and generates the second satellite information of the first satellite 2a based on the second satellite signal received by the receiving section 10 in step S11.

Specifically, in step S121, the satellite information generation unit 31 acquires the navigation message of the first satellite signal in the L1 band from the baseband processing unit 26 and acquires the navigation message of the second satellite signal in the L5 band from the tracking processing unit 27.

Then, the satellite information generation unit 31 determines whether the processing load on the processing section 30 is equal to or more than a predetermined value in step S123, when the processing load on the processing section 30 is less than the predetermined value, in step S124, calculates the position of the first satellite 2a in the first satellite signal in the L1 band based on the navigation message in the L1 band acquired in step S121, calculates the position of the first satellite 2a in the second satellite signal in the L5 band based on the navigation message in the L5 band acquired in step S121, and generates the first satellite information and the second satellite information each h including the value of the position of the first satellite 2a. Then, in step S125, the satellite information generation unit 31 sets the determination mode of the determination unit 32 to the first determination mode.

When the processing load on the processing section 30 is equal to or more than the predetermined value in step S123, in step S126, the satellite information generation unit 31 calculates each orbit determination element of the first satellite 2a in the first satellite signal in the L1 band based on the navigation message in the L1 band acquired in step S121 and calculates each orbit determination element of the first satellite 2a in the second satellite signal in the L5 band based on the navigation message in the L5 band acquired in step S121. The orbit determination elements calculated in step S126 are, for example, the right ascension of ascending node Ω, the inclination i, the argument of perigee ω, and the true anomaly ν, and the satellite information generation unit 31 generates the first satellite information and the second satellite information including the values of these orbit determination elements, respectively. Then, in step S127, the satellite information generation unit 31 sets the determination mode of the determination unit 32 to the second determination mode.

Then, in steps S131 to S136 contained in a determination step S3, the determination unit 32 determines whether the first satellite 2a is spoofed.

Specifically, when the first determination mode is set in step S125, in step S131, the determination unit 32 calculates the difference between the position of the first satellite 2a in the first satellite signal in the L1 band and the position of the first satellite 2a in the second satellite signal in the L5 band calculated in step S124. Then, when the difference calculated in step S131 is equal to or more than the threshold in step S132, the determination unit 32 determines that the first satellite 2a is spoofed in step S133, and, when the difference is less than the threshold in step S132, determines that the first satellite 2a is not spoofed in step S134.

When the second determination mode is set in step S127, in step S135, the determination unit 32 calculates the difference between each orbit determination element in the first satellite signal in the L1 band and each orbit determination element in the second satellite signal in the L5 band calculated in step S126. Then, when at least one difference calculated in step S135 is equal to or more than a threshold in step S136, the determination unit 32 determines that the first satellite 2a is spoofed in step S133, and when all the differences are less than the threshold in step S136, the determination unit 32 determines that the first satellite 2a is not spoofed in step S134.

Then, in step S41 contained in the control step S4, when it is determined in the determination step S3 that the first satellite 2a is spoofed, the control unit 33 performs control not to perform positioning using the first satellite information and the second satellite information of the first satellite 2a in the positioning step S5.

When it is determined that the first satellite 2a is spoofed, the positioning unit 34 performs positioning without using the first satellite information and the second satellite information of the first satellite 2a in the positioning step S5.

FIG. 11 is a flowchart showing another example of the procedure of the positioning method with a focus on a spoofing determination with respect to a certain first satellite 2a among the plurality of satellites 2 regarding steps S1 to S5 of the flowchart shown in FIG. 7. In FIG. 11, the same steps as those in FIG. 7 or 10 have the same signs. In the flowchart shown in FIG. 11, step S122 is added between step S121 and step S123 in the flowchart shown in FIG. 10.

As shown in FIG. 11, in step S122, the satellite information generation unit 31 determines whether a caution against spoofing is essential. For example, the satellite information generation unit 31 makes the determination in consideration of the possibility that the area is in the spoofing attack environment. When it is determined in step S122 that the caution against spoofing is essential, the satellite information generation unit 31 performs the processing in steps S123 to S127 like that in FIG. 10, and when it is determined that the caution against spoofing is not essential, performs the processing in steps S126 and S127 as that in FIG. 10.

Since the other steps in the flowchart in FIG. 11 are the same as that in FIG. 10, the description thereof will be omitted.

In the present embodiment, the processing section 30 executes the processing in steps S2 to S5 in FIG. 7 and FIG. 10 or FIG. 11 by executing the positioning program 41. In other words, the positioning program 41 is a program that causes the processing section 30 as a computer to execute each procedure in steps S2 to S5 in FIG. 7 and FIG. 10 or FIG. 11.

According to the positioning device 1 of the third embodiment described above, it is possible to switch between first determination mode for a spoofing determination with high accuracy and the second determination mode for a simple spoofing determination with the reduced processing load according to the situation.

In addition, according to the positioning device 1 of the third embodiment, the same effects as those of the positioning device 1 of the first embodiment or the second embodiment can be obtained.

### 4. Fourth Embodiment

Hereinafter, in a fourth embodiment, the same component elements as those in the first to third embodiments have the same signs, the overlapping description with that in one of the first to third embodiments will be omitted or simplified, and the differences from any one of the first to third embodiments will be mainly described.

The configuration of the positioning device 1 of the fourth embodiment is the same as that in FIG. 1, and the illustration and description thereof will be omitted. However, in the positioning device 1 of the fourth embodiment, the processing of the determination unit 32 is different from that of the first to third embodiments.

In the fourth embodiment, the determination unit 32 compares a first difference as a difference between a value of a predetermined parameter contained in the first satellite information of the first satellite 2a among the plurality of satellites 2 and a value of the predetermined parameter contained in the second satellite information of the first satellite 2a with a second difference as a difference between a value of a predetermined parameter contained in the first satellite information of the second satellite 2b among the plurality of satellites 2 and a value of the predetermined parameter contained in the second satellite information of the second satellite 2b, and determines whether the first satellite 2a or the second satellite 2b is spoofed. For example, the determination unit 32 determines whether the first satellite 2a or the second satellite 2b is spoofed based on the difference between the first difference and the second difference.

For example, the predetermined parameter may be the position of each satellite 2. That is, the determination unit 32 may compare a first difference as a difference between a value of the position of the first satellite 2a contained in the first satellite information of the first satellite 2a and a value of the position of the first satellite 2a contained in the second satellite information of the first satellite 2a with a second difference as a difference between a value of the position of the second satellite 2b contained in the first satellite information of the second satellite 2b and a value of the position of the second satellite 2b contained in the second satellite information of the second satellite 2b, and determine whether the first satellite 2a or the second satellite 2b is spoofed.

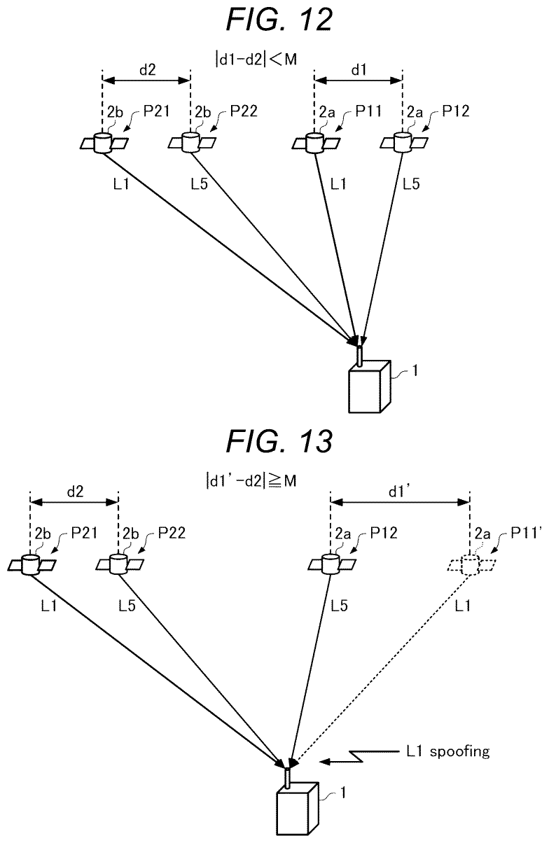

For example, as illustrated in FIG. 12, at a certain time, a distance as a difference between a position P11 of a certain first satellite 2a among the plurality of satellites 2 calculated based on the satellite signal in the L1 band transmitted from the first satellite 2a and a position P12 of the first satellite 2a calculated based on the satellite signal in the L5 band transmitted from the first satellite 2a is d1. At the same time, a distance as a difference between a position P21 of a certain second satellite 2b among the plurality of satellites 2 calculated based on the satellite signal in the L1 band transmitted from the second satellite 2b and a position P22 of the second satellite 2b calculated based on the satellite signal in the L5 band transmitted from the second satellite 2b is d2. The difference between the distance d1 and the distance d2 is supposed to be less than a predetermined first threshold M. In contrast, as shown in FIG. 13, when the satellite signal in the L1 band transmitted from the first satellite 2a is subjected to a spoofing attack, since the position of the first satellite 2a calculated based on the satellite signal in the L1 band is a position P11′ far from the actual position, a difference between a distance d1′ as a difference between the position P11′ and the position P12 and the distance d2 is equal to or more than the predetermined first threshold M.

Therefore, the determination unit 32 can determine whether the first satellite 2a is spoofed based on a third difference as a difference between the first difference as the difference between the value of the position of the first satellite 2a contained in the first satellite information of the first satellite 2a and the value of the position of the first satellite 2a contained in the second satellite information of the first satellite 2a and the second difference as the difference between the value of the position of the second satellite 2b contained in the first satellite information of the second satellite 2b and the value of the position of the second satellite 2b contained in the second satellite information of the second satellite 2b. Specifically, when the third difference is equal to or more than the predetermined first threshold, the determination unit 32 determines that the first satellite 2a or the second satellite 2b is spoofed. Furthermore, when the third difference is equal to or more than the predetermined first threshold, the determination unit 32 may determine that the first satellite 2a is spoofed when the first difference is more than the second difference, and may determine that the second satellite 2b is spoofed when the second difference is more than the first difference. The first threshold is set to a value more than an error range of the difference between the position of the first satellite 2a and the position of the second satellite 2b so that an error and a spoofing attack can be distinguished. Since the error range of the difference between the position of the first satellite 2a and the position of the second satellite 2b depends on the accuracy requirements of the application and the system, the first threshold is also set to a value according to the accuracy requirements.

When the third difference is less than the predetermined first threshold, the determination unit 32 may determine that the first satellite 2a and the second satellite 2b are not spoofed. However, though in a rare case, when the first satellite 2a and the second satellite 2b are spoofed, the first difference and the second difference are equal to or more than a predetermined second threshold, and when the first difference and the second difference are close values, the third difference may be less than the first threshold as a result. Therefore, when the third difference is less than the predetermined first threshold and when both the first difference and the second difference are less than the second threshold, the determination unit 32 may determine that the first satellite 2a and the second satellite 2b are not spoofed.

The control unit 33 controls the positioning unit 34 not to perform the positioning using the first satellite information and the second satellite information of the first satellite 2a when the determination unit 32 determines that the first satellite 2a is spoofed, and controls the positioning unit 34 not to perform the positioning using the first satellite information and the second satellite information of the second satellite 2b when the determination unit 32 determines that the second satellite 2b is spoofed. Accordingly, the positioning unit 34 performs positioning using the first satellite information or the second satellite information of four or more satellites 2 except at least one of the first satellite 2a and the second satellite 2b among the plurality of captured satellites 2.

The predetermined parameter may be an orbit determination element of each satellite 2 like that in the second embodiment. That is, the determination unit 32 may determine whether the first satellite 2a is spoofed based on a third difference as a difference between a first difference as a difference between the value of the orbit determination element of the first satellite 2a contained in the first satellite information of the first satellite 2a and the value of the orbit determination element of the first satellite 2a contained in the second satellite information of the first satellite 2a and a second difference as a difference between the value of the orbit determination element of the second satellite 2b contained in the first satellite information of the second satellite 2b and the value of the orbit determination element of the second satellite 2b contained in the second satellite information of the second satellite 2b.

The other configurations and functions of the positioning device 1 of the fourth embodiment are the same as those of the first to third embodiments, and thus the description thereof will be omitted.

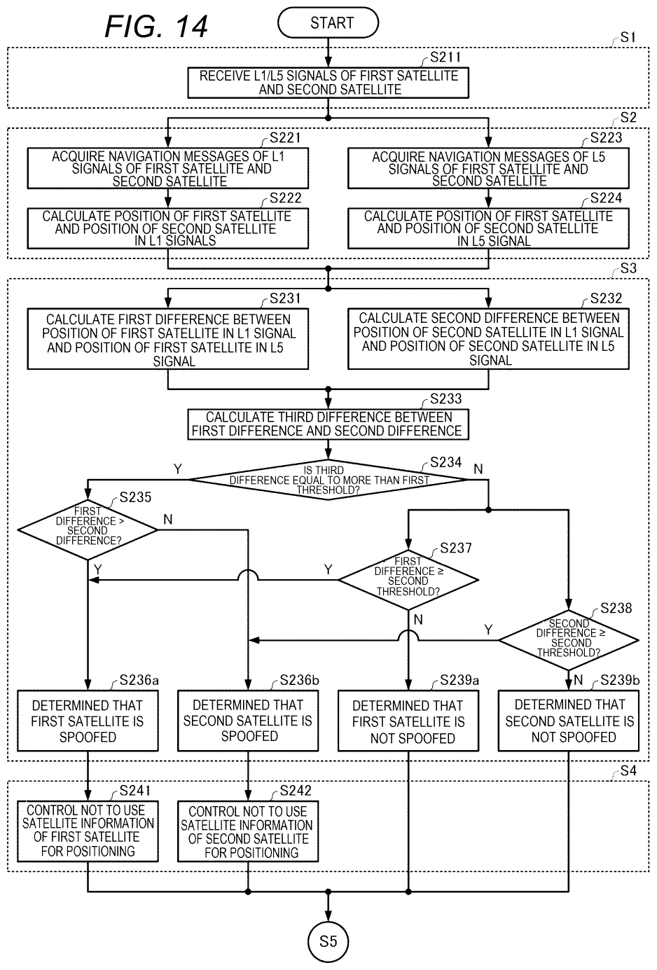

A flowchart showing an example of a procedure of a positioning method performed by the positioning device 1 of the fourth embodiment is the same as that in FIG. 7, and the illustration and description thereof will be omitted. FIG. 14 is a flowchart showing an example of the procedure of the positioning method with a focus on a spoofing determination with respect to certain first satellite 2a and second satellite 2b among the plurality of satellites 2 regarding steps S1 to S5 of the flowchart shown in FIG. 7. In FIG. 14, the same steps as those in FIG. 7 have the same signs.

As shown in FIG. 14, first, in step S211 contained in the reception step S1, the receiving section 10 receives the first satellite signal in the L1 band and the second satellite signal in the L5 band transmitted from the first satellite 2a, and receives a third satellite signal in the L1 band and a fourth satellite signal in the L5 band transmitted from the second satellite 2b.

Then, in steps S221, S222, S223, and S224 contained in the satellite information generation step S2, the satellite information generation unit 31 generates the first satellite information and the second satellite information of the first satellite 2a based on the first satellite signal and the second satellite signal received by the receiving section 10 in step S211, and generates the first satellite information and the second satellite information of the second satellite 2b based on the third satellite signal and the fourth satellite signal received by the receiving section 10 in step S211.

Specifically, in step S221, the satellite information generation unit 31 acquires the navigation message of the first satellite signal in the L1 band and the navigation message of the third satellite signal in the L1 band from the baseband processing unit 26, and, in step S222, calculates the position of the first satellite 2a in the first satellite signal in the L1 band and the position of the second satellite 2b in the third satellite signal in the L1 band based on the navigation messages acquired in step S221. Then, the satellite information generation unit 31 generates the first satellite information of the first satellite 2a including values of a plurality of parameters such as a position of the first satellite 2a and an orbit determination element, and the first satellite information of the second satellite 2b including values of a plurality of parameters such as a position of the second satellite 2b and an orbit determination element.

Furthermore, in step S223, the satellite information generation unit 31 acquires the navigation message of the second satellite signal in the L5 band and the navigation message of the fourth satellite signal in the L5 band from the tracking processing unit 27, and, in step S224, calculates the position of the first satellite 2a in the second satellite signal in the L5 band and the position of the second satellite 2b in the fourth satellite signal in the L5 band based on the navigation messages acquired in step S223. The satellite information generation unit 31 generates the second satellite information of the first satellite 2a including values of a plurality of parameters such as the position of the first satellite 2a and the orbit determination element, and the second satellite information of the second satellite 2b including values of a plurality of parameters such as the position of the second satellite 2b and the orbit determination element.

Then, in steps S231 to S239b contained in the determination step S3, the determination unit 32 compares the first difference as the difference between the value of the predetermined parameter contained in the first satellite information of the first satellite 2a based on the first satellite signal and the value of the predetermined parameter contained in the second satellite information of the first satellite 2a based on the second satellite signal with the second difference as the difference between the value of the predetermined parameter contained in the first satellite information of the second satellite 2b based on the third satellite signal the value of the predetermined parameter contained in the second satellite information of the second satellite 2b based on the fourth satellite signal, and determines whether the first satellite 2a or the second satellite 2b is spoofed. In the present embodiment, the predetermined parameter is the position of the first satellite 2a, and the determination unit 32 determines whether the first satellite 2a or the second satellite 2b is spoofed based on the third difference as the difference between the first difference as the difference between the value of the position of the first satellite 2a contained in the first satellite information of the first satellite 2a and the value of the position of the first satellite 2a contained in the second satellite information of the first satellite 2a and the second difference as the difference between the value of the position of the second satellite 2b contained in the first satellite information of the second satellite 2b and the value of the position of the second satellite 2b contained in the second satellite information of the second satellite 2b.

Specifically, in step S231, the determination unit 32 calculates the first difference between the position of the first satellite 2a in the first satellite signal in the L1 band calculated in step S222 and the position of the first satellite 2a in the second satellite signal in the L5 band calculated in step S224. Furthermore, in step S232, the determination unit 32 calculates the second difference between the position of the second satellite 2b in the third satellite signal in the L1 band calculated in step S222 and the position of the second satellite 2b in the fourth satellite signal in the L5 band calculated in step S224. Moreover, in step S233, the determination unit 32 calculates the third difference between the first difference calculated in step S231 and the second difference calculated in step S232.

Then, in step S234, when the third difference calculated in step S233 is equal to or more than the first threshold, in step S235, the determination unit 32 determines that the first satellite 2a is spoofed in step S236a when the first difference calculated in step S231 is more than the second difference calculated in step S232, and determines that the second satellite 2b is spoofed in step S236b when the second difference is more than the first difference in step S235.

Furthermore, when the third difference is less than the first threshold in step S234, the determination unit 32 determines that the first satellite 2a is spoofed in step S236a when the first difference is equal to or more than the second threshold in step S237, and determines that the first satellite 2a is not spoofed in step S239a when the first difference is less than the second threshold in step S237.

Moreover, the determination unit 32 determines that the second satellite 2b is spoofed in step S236b when the third difference is less than the first threshold in step S234 and the second difference is equal to or more than the second threshold in step S238, and determines that the second satellite 2b is not spoofed in step S239b when the second difference is less than the second threshold in step S238.

Then, in step S241 contained in the control step S4, when it is determined in the determination step S3 that the first satellite 2a is spoofed, the control unit 33 performs control not to perform positioning using the first satellite information and the second satellite information of the first satellite 2a in the positioning step S5. Furthermore, in step S242 contained in the control step S4, when it is determined in the determination step S3 that the second satellite 2b is spoofed, the control unit 33 performs control not to perform positioning using the first satellite information and the second satellite information of the second satellite 2b in the positioning step S5.

Then, when it is determined that the first satellite 2a is spoofed, the positioning unit 34 performs positioning without using the first satellite information and the second satellite information of the first satellite 2a in the positioning step S5, and when it is determined that the second satellite 2b is spoofed, the positioning unit 34 performs positioning without using the first satellite information and the second satellite information of the second satellite 2b in the positioning step S5.

In the present embodiment, the processing section 30 executes the processing in steps S2 to S5 in FIGS. 7 and 14 by executing the positioning program 41. In other words, the positioning program 41 is a program that causes the processing section 30 as a computer to execute each procedure in steps S2 to S5 in FIGS. 7 and 14.

In the positioning device 1 of the fourth embodiment described above, when the first satellite signal and the second satellite signal of the first satellite 2a are not subjected to a spoofing attack, the first difference as the difference between the value of the predetermined parameter contained in the first satellite information of the first satellite 2a and the value of the predetermined parameter contained in the second satellite information of the first satellite 2a is smaller. Similarly, when the third satellite signal and the fourth satellite signal of the second satellite 2b are not subjected to a spoofing attack, the second difference as the difference between the value of the predetermined parameter contained in the first satellite information of the second satellite 2b and the value of the predetermined parameter contained in the second satellite information of the second satellite 2b is smaller. Therefore, the difference between the first difference and the second difference is smaller.

In contrast, when the first satellite signal or the second satellite signal is subjected to a spoofing attack, the first difference is larger, and when the third satellite signal or the fourth satellite signal is subjected to a spoofing attack, the second difference is larger, so that the difference between the first difference and the second difference is larger in either case. Therefore, according to the positioning device 1 of the fourth embodiment, it is possible to determine whether the first satellite 2a or the second satellite 2b is spoofed by comparing the first difference with the second difference. Furthermore, according to the positioning device 1 of the fourth embodiment, when it is determined that the first satellite 2a is spoofed, the positioning is not performed by using the first satellite information and the second satellite information of the first satellite 2a, and when it is determined that the second satellite 2b is spoofed, the positioning is not performed by using the first satellite information and the second satellite information of the second satellite 2b, thereby reducing the possibility of a false positioning result in an environment of the spoofing attack.

Moreover, in the positioning device 1 of the fourth embodiment, since a spoofing can be determined using the first satellite signal and the third satellite signal in the first frequency band such as the L1 band and the second satellite signal and the fourth satellite signal in the second frequency band such as the L5 band different from the first frequency band, it is not necessary to receive the satellite signal using an antenna having a narrow coverage. Therefore, according to the positioning device 1 of the fourth embodiment, the positioning can be performed without reducing the number of captured satellites 2 as much as possible even in the environment of the spoofing attack, and thus it is possible to reduce the possibility of lowering of the positioning accuracy.

In addition, according to the positioning device 1 of the fourth embodiment, the same effects as those of the positioning device 1 of any one of the first to third embodiments can be obtained.

The present disclosure is not limited to the embodiments, and various modifications can be implemented within the scope of the gist of the present disclosure.

The embodiment and the modifications described above are illustrative only, and the present disclosure is not limited thereto. For example, the embodiments and the modifications can be combined as appropriate.

The present disclosure includes substantially the same configurations as the configurations described in the embodiments, such as configurations having the same functions, methods, and results, or configurations having the same objects and advantages. Furthermore, the present disclosure includes configurations obtained by replacing non-essential portions of the configurations described in the embodiments. Moreover, the present disclosure includes configurations that exert the same functions and effects or configurations that can achieve the same objects as those of the configurations described in the embodiments. In addition, the present disclosure includes configurations obtained by addition of a known technique to the configurations described in the embodiments.

The following configurations are derived from the embodiments and modifications described above.

A positioning device according to an aspect of the present disclosure includes a receiving unit that receives a first satellite signal in a first frequency band and a second satellite signal in a second frequency band different from the first frequency band transmitted from a first satellite, a positioning unit, a determination unit that compares a value of a predetermined parameter contained in first satellite information of the first satellite based on the first satellite signal with a value of the predetermined parameter contained in second satellite information of the first satellite based on the second satellite signal, and determines whether the first satellite is spoofed, and a control unit that controls the positioning unit not to perform positioning using the first satellite information and the second satellite information of the first satellite when the determination unit determines that the first satellite is spoofed.

In the positioning device, when the first satellite signal and the second satellite signal are not subjected to a spoofing attack, the difference between the value of the predetermined parameter contained in the first satellite information of the first satellite and the value of the predetermined parameter contained in the second satellite information of the first satellite is smaller. In contrast, when the first satellite signal or the second satellite signal is subjected to a spoofing attack, the difference between the value of the predetermined parameter contained in the first satellite information of the first satellite and the value of the predetermined parameter contained in the second satellite information of the first satellite is larger. Therefore, according to the positioning device, it is possible to determine whether the first satellite is spoofed by comparing the value of the predetermined parameter contained in the first satellite information of the first satellite with the value of the predetermined parameter contained in the second satellite information of the first satellite. Furthermore, according to the positioning device, when it is determined that the first satellite is spoofed, the positioning is not performed by using the first satellite information and the second satellite information of the first satellite, thereby reducing the possibility of a false positioning result in an environment of the spoofing attack.

Moreover, in the positioning device, since a spoofing can be determined using the first satellite signal in the first frequency band and the second satellite signal in the second frequency band different from the first frequency band, it is not necessary to receive the satellite signal by using an antenna having a narrow coverage. Therefore, according to the positioning device, the positioning can be performed without reducing the number of captured satellites as much as possible even in the environment of the spoofing attack, and thus it is possible to reduce the possibility of lowering of the positioning accuracy.

In the positioning device according to the aspect of the present disclosure, the predetermined parameter may be a position of the first satellite, and the determination unit may determine whether the first satellite is spoofed based on a difference between a value of the position contained in the first satellite information of the first satellite and a value of the position contained in the second satellite information of the first satellite.

In the positioning device, since the position of the first satellite is calculated by using a large number of orbit determination elements, when some of these orbit determination elements become false values by a spoofing attack, the calculated position value is also false. Therefore, according to the positioning device, it is possible to accurately determine whether the first satellite is spoofed based on the difference between the value of the position contained in the first satellite information of the first satellite and the value of the position contained in the second satellite information of the first satellite.

In the positioning device according to the aspect of the present disclosure, the predetermined parameter may be an orbit determination element of the first satellite, and the determination unit may determine whether the first satellite is spoofed based on a difference between a value of the orbit determination element contained in the first satellite information of the first satellite and a value of the orbit determination element contained in the second satellite information of the first satellite.

According to the positioning device, it is possible to easily determine whether the first satellite is spoofed based on the difference between the value of the orbit determination element contained in the first satellite information of the first satellite and the value of the orbit determination element contained in the second satellite information of the first satellite. Furthermore, according to the positioning device, it is not necessary to calculate the position of the first satellite in order to determine whether the first satellite is spoofed, thereby reducing the processing load.

In the positioning device according to the aspect of the present disclosure, the predetermined parameter may be a position of the first satellite, and the determination unit may have a first determination mode of determining whether the first satellite is spoofed based on a difference between a value of the position contained in the first satellite information of the first satellite and a value of the position contained in the second satellite information of the first satellite, and a second determination mode of determining whether the first satellite is spoofed based on a difference between a value of an orbit determination element of the first satellite contained in the first satellite information of the first satellite and a value of the orbit determination element contained in the second satellite information of the first satellite.

According to the positioning device, it is possible to switch between the first determination mode for a spoofing determination with high accuracy and the second determination mode for a simple spoofing determination with reduced processing load according to the situation.

In the positioning device according to the aspect, the first frequency band may be an L1 band, and the second frequency band may be an L5 band.

A positioning device according to another aspect of the present disclosure includes a receiving unit that receives a first satellite signal in a first frequency band and a second satellite signal in a second frequency band different from the first frequency band transmitted from a first satellite, and receives a third satellite signal in the first frequency band and a fourth satellite signal in the second frequency band transmitted from a second satellite, a positioning unit, a determination unit that compares a first difference as a difference between a value of a predetermined parameter contained in first satellite information of the first satellite based on the first satellite signal and a value of the predetermined parameter contained in second satellite information of the first satellite based on the second satellite signal with a second difference as a difference between a value of the predetermined parameter contained in first satellite information of the second satellite based on the third satellite signal and a value of the predetermined parameter contained in second satellite information of the second satellite based on the fourth satellite signal, and determines whether the first satellite or the second satellite is spoofed, and a control unit that controls the positioning unit not to perform positioning using the first satellite information and the second satellite information of the first satellite when the determination unit determines that the first satellite is spoofed, and controls the positioning unit not to perform positioning using the first satellite information and the second satellite information of the second satellite when the determination unit determines that the second satellite is spoofed.

In the positioning device, when the first satellite signal and the second satellite signal of the first satellite are not subjected to a spoofing attack, the first difference as the difference between the value of the predetermined parameter contained in the first satellite information of the first satellite and the value of the predetermined parameter contained in the second satellite information of the first satellite is smaller. Similarly, when the third satellite signal and the fourth satellite signal of the second satellite are not subjected to a spoofing attack, the second difference as the difference between the value of the predetermined parameter contained in the first satellite information of the second satellite and the value of the predetermined parameter contained in the second satellite information of the second satellite is smaller. Therefore, the difference between the first difference and the second difference is smaller.

In contrast, when the first satellite signal or the second satellite signal is subjected to a spoofing attack, the first difference is larger, and when the third satellite signal or the fourth satellite signal is subjected to a spoofing attack, the second difference is larger, so that the difference between the first difference and the second difference is larger in either case. Therefore, according to the positioning device, it is possible to determine whether the first: the second satellite is spoofed by comparing the first difference with the second difference. Furthermore, according to the positioning device, when it is determined that the first satellite is spoofed, the positioning is not performed by using the first satellite information and the second satellite information of the first satellite, and when it is determined that the second satellite is spoofed, the positioning is not performed by using the first satellite information and the second satellite information of the second satellite, thereby reducing the possibility of a false positioning result in an environment of the spoofing attack.

Furthermore, in the positioning device, since a spoofing can be determined using the first satellite signal and the third satellite signal in the first frequency band and the second satellite signal and the fourth satellite signal in the second frequency band different from the first frequency band, it is not necessary to receive the satellite signal using an antenna having a narrow coverage. Therefore, according to the positioning device, the positioning can be performed without reducing the number of captured satellites as much as possible even in the environment of the spoofing attack, and thus it is possible to reduce the possibility of lowering of the positioning accuracy.

In the positioning device according to the aspect, the determination unit may determine that the first satellite or the second satellite is spoofed when a third difference as a difference between the first difference and the second difference is equal to or more than a first threshold.

In the positioning device, when the first satellite signal or the second satellite signal is subjected to a spoofing attack, the first difference is larger, and when the third satellite signal or the fourth satellite signal is subjected to a spoofing attack, the second difference is larger, so that the third difference as the difference between the first difference and the second difference is larger in either case. Therefore, according to the positioning device, it is possible to determine that the first satellite or the second satellite is spoofed when the third difference is equal to or more than the first threshold.

In the positioning device according to the aspect of the present disclosure, the determination unit may determine that the first satellite is spoofed when the third difference is equal to or more than the first threshold and the first difference is more than the second difference.

In the positioning device, when the first satellite signal or the second satellite signal is subjected to a spoofing attack, the first difference is larger and the first difference is more than the second difference. Therefore, according to the positioning device, it is possible to determine that the first satellite or the second satellite is spoofed when the third difference is equal to or more than the first threshold, and when the first difference is more than the second difference, it can be determined that the first satellite is spoofed.

In the positioning device according to the aspect, the determination unit may determine that the first satellite and the second satellite are not spoofed when a third difference as a difference between the first difference and the second difference is less than a first threshold and when both the first difference and the second difference are less than a second threshold.

In the positioning device, when neither the first satellite nor the second satellite is spoofed, both the first difference and the second difference are smaller, and therefore, the third difference is also smaller. However, when both the first satellite and the second satellite are spoofed, both the first difference and the second difference are larger, but the third difference may be smaller. Therefore, according to the positioning device, it is possible to determine that the first satellite and the second satellite are not spoofed when the third difference is less than the first threshold and both the first difference and the second difference are less than the second threshold.

A positioning method according to an aspect of the present disclosure includes a reception step of receiving a first satellite signal in a first frequency band and a second satellite signal in a second frequency band different from the first frequency band transmitted from a first satellite, a positioning step, a determination step of comparing a value of a predetermined parameter contained in first satellite information of the first satellite based on the first satellite signal with a value of the predetermined parameter contained in second satellite information of the first satellite based on the second satellite signal, and determining whether the first satellite is spoofed, and a control step of controlling not to perform positioning using the first satellite information and the second satellite information of the first satellite in the positioning step when it is determined in the determination step that the first satellite is spoofed.

According to the positioning method, it is possible to determine whether the first satellite is spoofed by comparing the value of the predetermined parameter contained in the first satellite information of the first satellite with the value of the predetermined parameter contained in the second satellite information of the first satellite. Furthermore, according to the positioning method, when it is determined that the first satellite is spoofed, the positioning is not performed using the first satellite information and the second satellite information of the first satellite, thereby reducing the possibility of a false positioning result in an environment of the spoofing attack. Moreover, according to the positioning method, the positioning can be performed without reducing the number of captured satellites as much as possible even in the environment of the spoofing attack, and thus it is possible to reduce the possibility of lowering of the positioning accuracy.

A non-transitory computer-readable storage medium storing a positioning program according to an aspect of the present disclosure, the positioning program causes a computer to execute a positioning step, a determination step of comparing a value of a predetermined parameter contained in first satellite information of a first satellite based on a first satellite signal in a first frequency band transmitted from the first satellite with a value of the predetermined parameter contained in second satellite information of the first satellite based on a second satellite signal in a second frequency band different from the first frequency band transmitted from the first satellite, and determining whether the first satellite is spoofed, and a control step of controlling not to perform positioning using the first satellite information and the second satellite information of the first satellite in the positioning step when it is determined in the determination step that the first satellite is spoofed.

According to the positioning program, the computer can determine whether the first satellite is spoofed by comparing the value of the predetermined parameter contained in the first satellite information of the first satellite with the value of the predetermined parameter contained in the second satellite information of the first satellite. Furthermore, according to the positioning program, since the computer does not perform the positioning using the first satellite information and the second satellite information of the first satellite when it is determined that the first satellite is spoofed, thereby reducing the possibility of a false positioning result in an environment of the spoofing attack. Furthermore, according to the positioning program, the computer performs the positioning without reducing the number of captured satellites as much as possible even in the environment of the spoofing attack, and thus it is possible to reduce the possibility of lowering of the positioning accuracy.

What is claimed is:

1. A positioning device comprising:
a receiving unit that receives a first satellite signal in a first frequency band and a second satellite signal in a second frequency band different from the first frequency band transmitted from a first satellite;
a positioning unit;
a determination unit that compares a value of a predetermined parameter contained in first satellite information of the first satellite based on the first satellite signal with a value of the predetermined parameter contained in second satellite information of the first satellite based on the second satellite signal, and determines whether the first satellite is a genuine satellite; and
a control unit that controls the positioning unit not to perform positioning using the first satellite signal and the second satellite signal of the first satellite when the determination unit determines that the first satellite is not a genuine satellite.

2. The positioning device according to claim 1, wherein
the predetermined parameter is a position of the first satellite, and
the determination unit determines whether the first satellite is a genuine satellite based on a difference between a value of the position contained in the first satellite information of the first satellite and a value of the position contained in the second satellite information of the first satellite.

3. The positioning device according to claim 1, wherein
the predetermined parameter is an orbit determination element of the first satellite, and
the determination unit determines whether the first satellite is a genuine satellite based on a difference between a value of the orbit determination element contained in the first satellite information of the first satellite and a value of the orbit determination element contained in the second satellite information of the first satellite.

4. The positioning device according to claim 1, wherein
the predetermined parameter is a position of the first satellite, and
the determination unit has:
a first determination mode of determining whether the first satellite is a genuine satellite based on a difference between a value of the position contained in the first satellite information of the first satellite and a value of the position contained in the second satellite information of the first satellite; and
a second determination mode of determining whether the first satellite is a genuine satellite based on a difference between a value of an orbit determination element of the first satellite contained in the first satellite information of the first satellite and a value of the orbit determination element contained in the second satellite information of the first satellite.

5. The positioning device according to claim 1, wherein
the first frequency band is an L1 band, and
the second frequency band is an L5 band.

6. A positioning device comprising:
a receiving unit that receives a first satellite signal in a first frequency band and a second satellite signal in a second frequency band different from the first frequency band transmitted from a first satellite, and receives a third satellite signal in the first frequency band and a fourth satellite signal in the second frequency band transmitted from a second satellite;
a positioning unit;
a determination unit that compares a first difference as a difference between a value of a predetermined parameter contained in first satellite information of the first satellite based on the first satellite signal and a value of the predetermined parameter contained in second satellite information of the first satellite based on the second satellite signal with a second difference as a difference between a value of the predetermined parameter contained in first satellite information of the second satellite based on the third satellite signal and a value of the predetermined parameter contained in second satellite information of the second satellite based on the fourth satellite signal, and determines whether the first satellite or the second satellite is a genuine satellite; and
a control unit that controls the positioning unit not to perform positioning using the first satellite signal and the second satellite signal of the first satellite when the determination unit determines that the first satellite is not a genuine satellite, and controls the positioning unit not to perform positioning using the first satellite signal and the second satellite signal of the second satellite when the determination unit determines that the second satellite is not a genuine satellite.

7. The positioning device according to claim 6, wherein
the determination unit determines that the first satellite or the second satellite is not a genuine satellite when a third difference as a difference between the first difference and the second difference is equal to or more than a first threshold.

8. The positioning device according to claim 7, wherein
the determination unit determines that the first satellite is not a genuine satellite when the third difference is equal to or more than the first threshold and the first difference is more than the second difference.

9. The positioning device according to claim 6, wherein
the determination unit determines that the first satellite and the second satellite are genuine satellites when a third difference as a difference between the first difference and the second difference is less than a first threshold and when both the first difference and the second difference are less than a second threshold.

10. A positioning method comprising:
a reception step of receiving a first satellite signal in a first frequency band and a second satellite signal in a second frequency band different from the first frequency band transmitted from a first satellite;
a positioning step;
a determination step of comparing a value of a predetermined parameter contained in first satellite information of the first satellite based on the first satellite signal with a value of the predetermined parameter contained in second satellite information of the first satellite based on the second satellite signal, and determining whether the first satellite is a genuine satellite; and
a control step of controlling not to perform positioning using the first satellite signal and the second satellite signal of the first satellite in the positioning step when it is determined in the determination step that the first satellite is not a genuine satellite.
